(19) United States
(12) Patent Application Publication
(10) Pub. No.: US 2014/0076912 A1
(43) Pub. Date: Mar. 20, 2014

(54) TIP RESISTANT REFUSE TOTE

(71) Applicant: Thomas Mattingly, South Jordan, UT (US)

(72) Inventor: Thomas Mattingly, South Jordan, UT (US)

(21) Appl. No.: 14/033,399

(22) Filed: Sep. 20, 2013

Related U.S. Application Data
(60) Provisional application No. 61/703,379, filed on Sep. 20, 2012.

(51) Int. Cl. B65F 1/16

(52) U.S. Cl. CPC B65F 1/16
USPC 220/810

(57) ABSTRACT

A refuse container having a system of weights and ballasts to prevent tipping and maintain a closed position of the container's lid following emptying of the refuse container.

### RELATED APPLICATIONS

This application claim priority to U.S. Provisional Patent Application Ser. No. 61/703,379, filed Sep. 20, 2013 and titled TIP RESISTANT REFUSE TOTE, which is incorporated herein in its entirety.

### BACKGROUND OF THE INVENTION

The current invention relates to a system of weights and ballasts that are configured to ensure lid closure and prevent tipping of a refuse tote. In particular, the present invention comprises a lid weight and a container ballast that are positioned at precise locations on a refuse tote to prevent tipping of the refuse tote and to prevent the lid from remaining in an opened position following emptying of the tote.

A refuse tote is a container that is used to store garbage, recyclables, and green waste prior to disposal. Conventional refuse totes are formed of relatively light-weight polymer materials. Some refuse totes include a container having a lid hingedly attached thereto. The interior of the container is accessed by lifting and temporarily removing the lid from an opening of the container. The contents of the tote are protected from the elements and animals by repositioning the lid onto the opening of the container.

The refuse container is typically emptied by a garbage truck having a clamp that picks up and inverts the tote into a hopper. The inverted position of the tote causes the lid to open under the force of gravity thereby releasing the contents of the tote into the truck. As the tote is returned to its upright position and returned to the ground, the lid of the refuse tote is commonly swung into an opened position. In some instances, the path of swinging lid causes the lid to contact and damage an item in proximity to the tote, such as a car, a person, or a vinyl fence. Further, the momentum created by the swinging lid may result in the tote tipping backwards and falling onto its side. Wind and animals may also cause the emptied refuse tote to tip over, further inconveniencing the owner and causing damage to nearby items.

Thus, while system and methods currently exist for disposing refuse, challenges still exist. Accordingly, it would be an improvement in the art to augment or even replace current techniques with other techniques.

### BRIEF SUMMARY OF THE INVENTION

In order to overcome the limitations discussed above, the present invention relates to a tip resistant refuse tote having a system of weights and ballasts that stabilize the refuse tote and ensure proper closure to the tote's lid following emptying of the refuse tote. Thus, the present invention provides a refuse tote that eliminates damage due to tipping and uncontrolled swinging of the tote's lid.

In some instances, a refuse tote is provided having a lid that is hingedly coupled to a container. The container further comprises a front, a rear, a left side, a right side, and an interior having a base. The base of the interior comprises a center of gravity. In some instances, a ballast is provided that is secured to the base at a position that is between the center of gravity and the front of the container, or at a position that is forward of the center of gravity. In some instances, the ballast comprises a weight that weighs approximately 40% of the weight of the emptied refuse tote.

The lid of the refuse container further comprises a front, a rear, a left side, a right side, an outer surface and an inner surface. In some instances, a weight is secured to the front of the lid, at a position that is opposite the hinged connection of the lid to the container, and at a position that is adjacent the front of the container. In some instances, the lid weight comprises a weight that weighs approximately 40% of the weight of the refuse tote lid.

The container ballast and the lid weight may include any size, shape, configuration that is compatible for placement on the refuse tote, as described herein. For example, in some instances a lid weight is provided that comprises a handle. Further, the container ballast and the lid weight may include any material sufficient to achieve the weight ratios described herein. For example, in some instances the container ballast and lid weight materials comprise metal, sand, concrete, water, and/or a polymer material.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. These drawings depict only typical embodiments of the invention and are not therefore to be considered to limit the scope of the invention.

FIG. 1 illustrates a perspective view of a refuse tote having a lid weight in accordance with a representative embodiment of the present invention.

FIG. 2 illustrates a cross-section side view of a refuse tote having a lid weight and a container ballast in accordance with a representative embodiment of the present invention.

FIG. 3, shown in parts A and B, illustrates a cross-section top view of a container portion of a refuse tote having a container ballast in accordance with various representative embodiments of the present invention.

FIG. 4, shown in parts A and B, illustrates various views of a refuse container having a lid weight handle in accordance with a representative embodiment of the present invention.

FIG. 5 illustrates a cross-section side view of a refuse tote having an integrated container ballast and lid weight in accordance with a representative embodiment of the present invention.

FIG. 6 illustrates a cross-section side view of a refuse tote having an imbedded container ballast and lid weight in accordance with a representative embodiment of the present invention.

### DETAILED DESCRIPTION OF THE INVENTION

The presently preferred embodiment of the present invention will be best understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

As used herein, the term “refuse tote” is understood to include any container having a hinged lid that is capable of containing refuse, such as garbage, recyclables, yard debris, green waste and other items for disposal.

A used herein, the term “center of gravity” is used to describe a coordinate position in the bottom of the container portion of the refuse tote from which the weight of the refuse tote is considered to act. In some embodiments, the center of gravity for the refuse tote is a center or central point on the bottom of the tote. In other embodiments, the center of gravity for the refuse tote is a point on the bottom of the tote at which the weight distribution between the front, rear, left side and right side of the refuse tote is balanced.

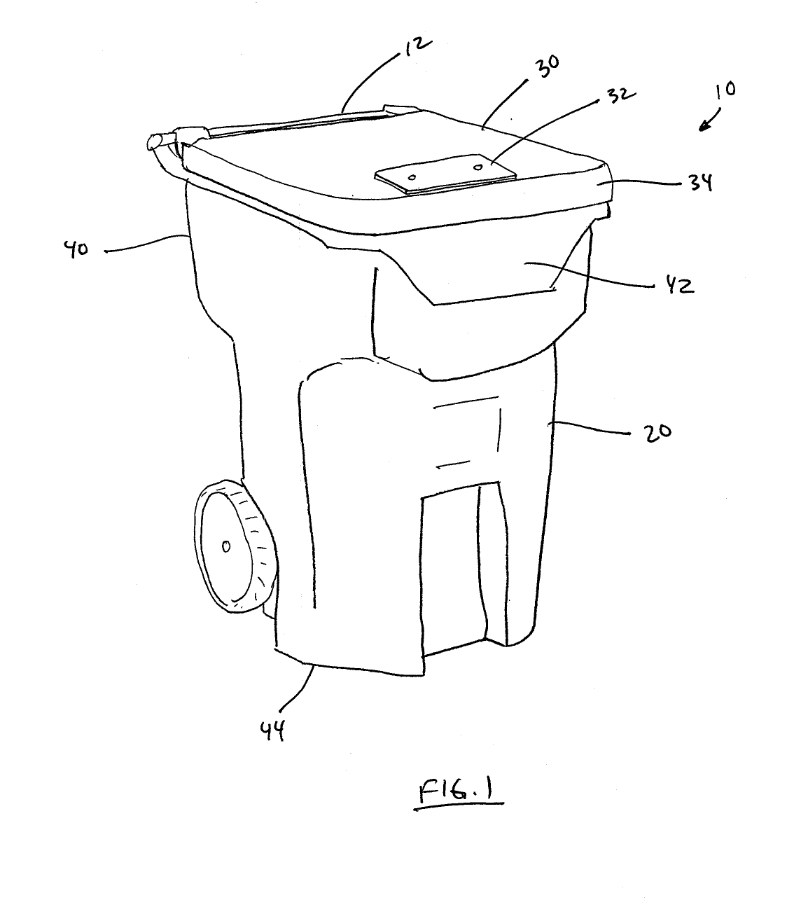

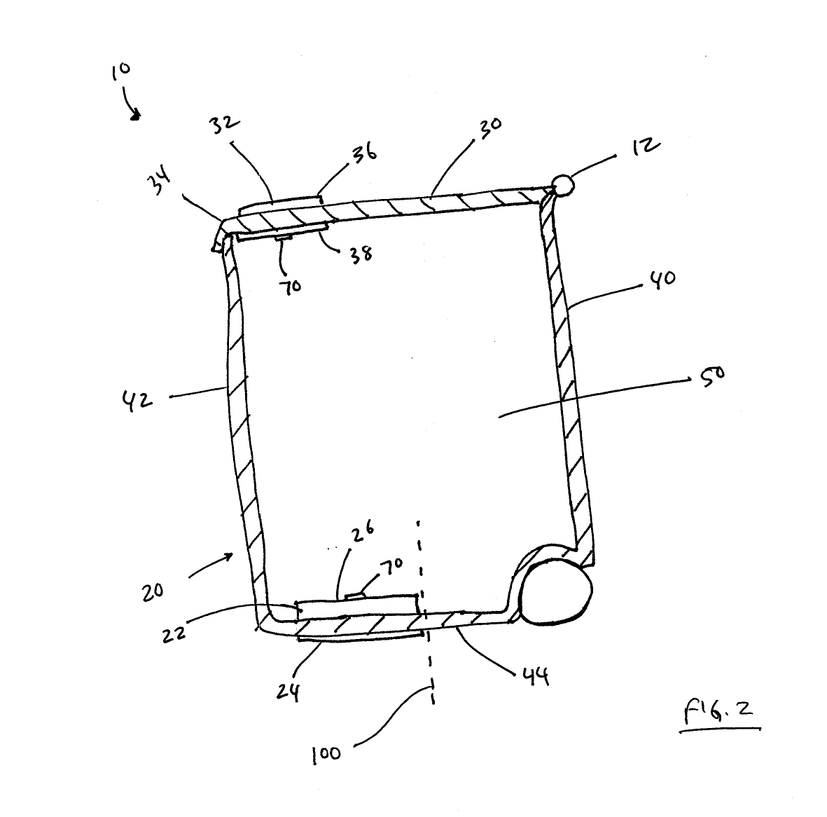

Referring now to FIG. 1, a refuse tote 10 is shown. In general, refuse tote 10 comprises a base container 20 having a lid 30 hingedly attached thereto. In some instances, lid 30 is hingedly coupled to a rear side 40 of container 20. Lid 30 and container 20 are configured to enclose an internal volume 50 that is designed to receive refuse, as shown in FIG. 2.

In some embodiments, refuse tote 10 comprises one or more weights that are strategically positioned to prevent tipping of tote 10 and maintain a closed position of lid 30. For example, in some embodiments tote 10 comprises a lid weight 32 that is attached to lid 30 at a position towards the front 34 of lid 30, and further at a position that is opposite the hinged connection 12 of lid 30 to container 20. Further still, in some embodiments, lid weight 32 is coupled to lid 30 at a position that is adjacent the front 42 of container 20, as shown in FIGS. 1 and 2. In general, it is desirable to position lid weight 32 at a position maximally distanced from hinged connection 12.

The precise position of lid weight 32 is generally centered on lid 30 at a position that is at the front 34 of lid 30. Lid weight 32 may include any material and/or shape that is compatible for use on a refuse container. In some instances, lid weight 32 comprises a metallic material, such as steel, aluminum, lead, iron and/or stainless steel. In other instances, lid weight 32 comprises a polymer material having sufficient density and/or weight. Further still, in some embodiments lid weight 32 comprises a composite material or a cementitious material.

In some instances, lid weight 32 comprises an outer plate 36 positioned on an outer surface of lid 30, and an inner plate 38 positioned on an inner surface of lid 30, wherein the outer and inner plates 36 and 38 sandwich a portion of lid 30 between the two plates. Outer and inner plates 36 and 38 may be secured to lid 30 by any compatible means. In some embodiments, outer and inner plates 36 and 38 are secured to each other and lid 30 via one or more fasteners 70, such as a bolt and nut fastener.

Lid weight 32 comprises an overall weight that is approximately 40% of the weight of lid 30. In other embodiments, lid weight 32 comprises an overall weight that is from approximately 15% to approximately 60% of the weight of lid 30. For example, in some embodiments lid weight 32 weighs approximately 4 pounds. In other embodiments, lid weight 32 weighs from approximately 2 pounds to approximately 10 pounds.

With continued reference to FIG. 2, some embodiments of the present invention further include a container ballast 22 that is attached to the bottom 44 of tote 20 at a position forward of the center of gravity 100. In some instances, ballast 22 is positioned such that a minority portion of ballast 22 is positioned at or rearward of center of gravity 100, and a majority portion of ballast 22 is positioned forward of center of gravity 100. In other embodiments, ballast 22 is positioned such that a rearward surface of ballast 22 is approximately equal with center of gravity 100, and the remaining ballast extends forward of center of gravity 100 towards front 42 of tote 20. Further, in some embodiments ballast 22 is approximately centered between center of gravity 100 and front 42 of tote 20. Further still, in some embodiments ballast 22 is secured to bottom 44 at a position that is maximally forward of center of gravity 100.

Container ballast 22 may include any material and/or shape that is compatible for use on a refuse container. In some instances ballast 22 comprises a metallic material, such as steel, lead, iron, aluminum, and/or stainless steel. In other instances, ballast 22 comprises a polymer material having sufficient density and/or weight. Further still, in some embodiments ballast 22 comprises a composite material or a cementitious material.

In some instances, ballast 22 comprises an outer plate 24 positioned on an outer surface of container 20, and an inner plate 26 positioned on an inner surface of container 20, wherein the outer and inner plates 24 and 26 sandwich a bottom portion 44 of container 20 between the two plates. Outer and inner plates 24 and 26 may be secured to container 20 by any compatible means. In some embodiments, outer and inner plates 24 and 26 are secured to each other and container 20 via one or more fasteners 70, such as a bolt and nut fastener.

Container ballast 22 comprises an overall weight that is approximately 40% of the weight of lid weight 32 and refuse tote 10, when empty. In other embodiments, ballast 22 comprises an overall weight that is from approximately 15% to approximately 60% of the weight of lid weight 32 and refuse tote 10, when empty. For example, in some embodiments container ballast 22 weighs approximately 20 pounds. In other embodiments, ballast 22 weighs from approximately 10 pounds to approximately 30 pounds.

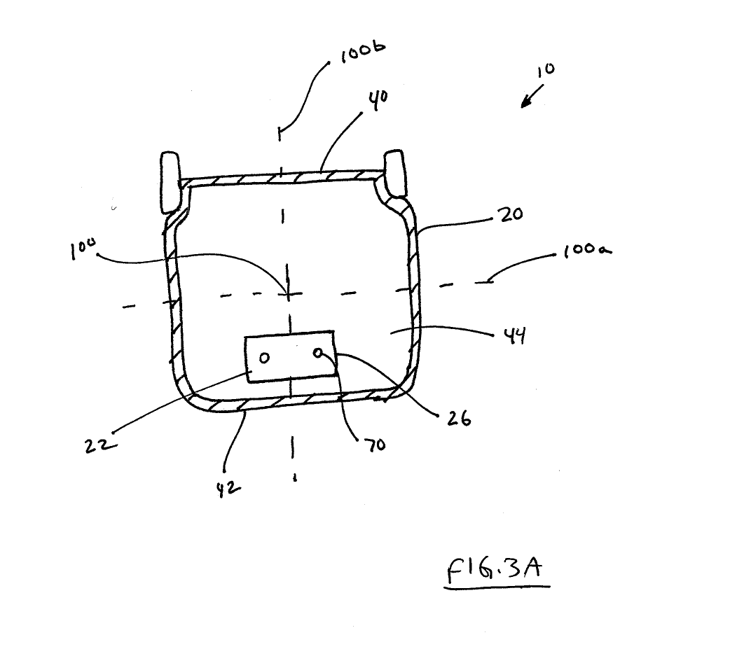

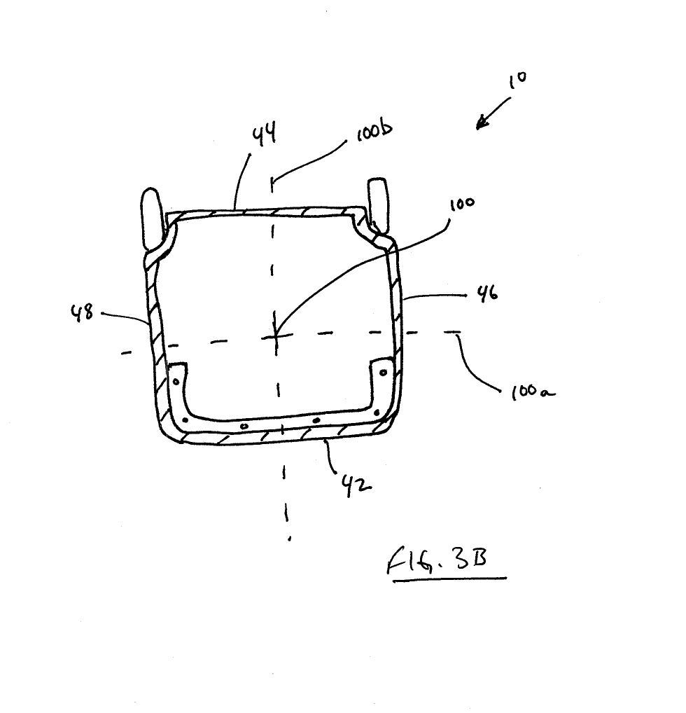

Referring now to FIG. 3A, a cross-section top view of container 20 is shown. In some embodiments, center of gravity 100 comprises an x-axis component 100a and a y-axis component 100b, wherein the intersection of the two axes 100a and 100b is the center of gravity 100. One having skill in the art will appreciate that the design of refuse tote 10 will necessarily shift the x-axis 100a and y-axis 100b components of center of gravity 100, thereby changing the possible positions of container ballast 22. Generally, where refuse tote 10 is symmetrical across the y-axis 100b, container ballast 22 may be centered on y-axis 100b, as shown.

In some embodiments, ballast 22 is U-shaped and configured for placement along front 42 and side walls 46 and 48 of container 20, as shown in FIG. 3B. In this configuration, ballast 22 is positioned in a maximally forward position and maximally outward position with respect to x-axis 100a and y-axis 100b.

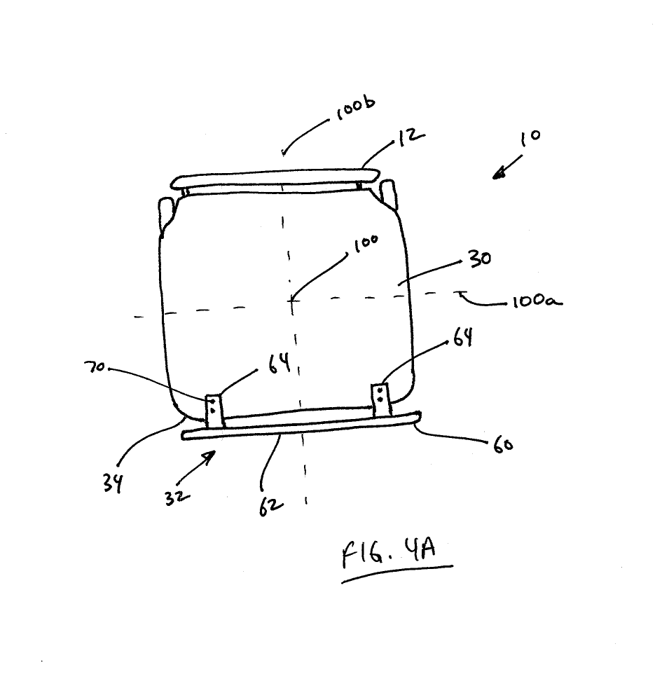

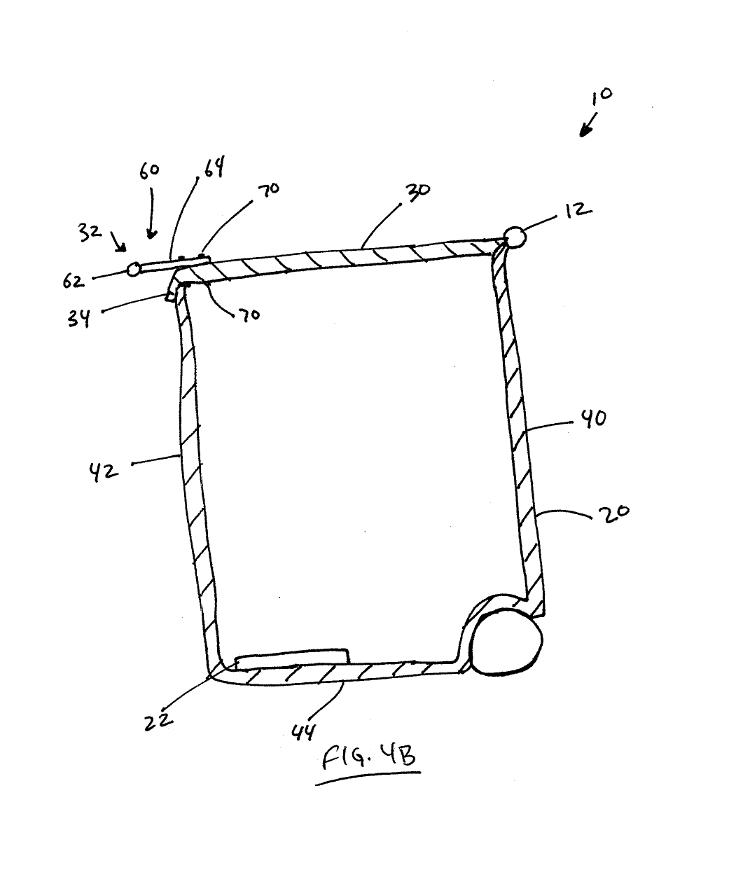

Referring now to FIGS. 4A and 4B, in some embodiments lid weight 32 comprises a handle 60. Handle 60 may include any size and shape that achieves the teachings of the present invention. In some instances, handle 60 comprises a bar 62 that is attached to front 34 of lid 30 via one or more tabs 64 and one or more fasteners 70. The position of bar 62 extends the distance between hinged connection 12 and lid weight 32. Further, the position of bar 62 shifts the weight of lid weight 32 to a position maximally forward of the x-axis 100a of center of gravity 100, thereby further assisting the function of container ballast 22. Thus, in some embodiments, lid weight 32 provides a utilitarian function as a handle 60 to assist a user in opening lid 30.

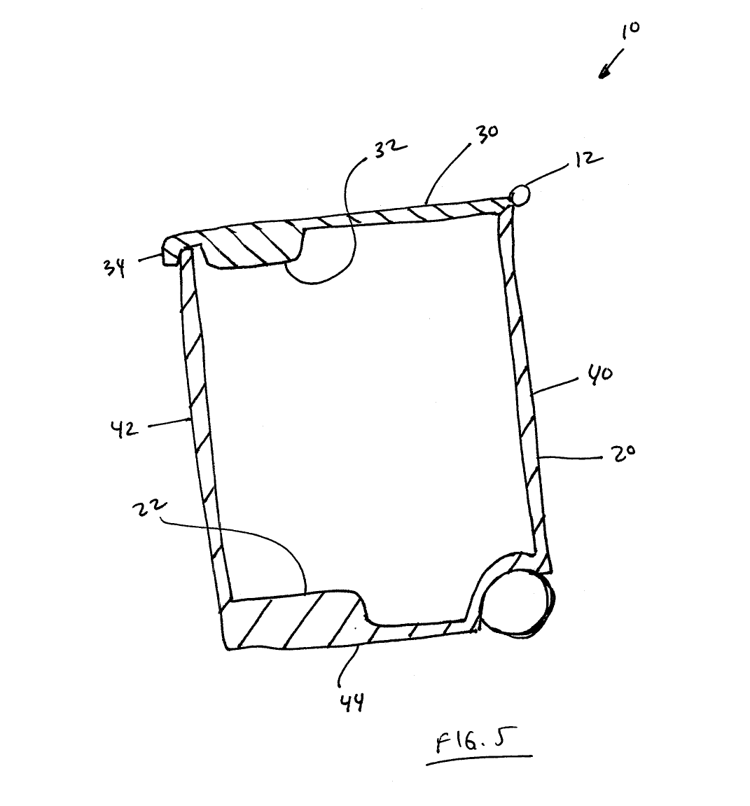

Referring now to FIG. 5, in some embodiments container ballast 22 and/or lid weight 32 comprise an integrated weight. For example, in some embodiments ballast 22 and lid weight 32 comprise a thickened portion of bottom 44 of container 20 and a thickened portion of lid 30. In some instances, the thickened portions of bottom 44 and lid 30 comprise a polymer material having a greater density than the remaining polymer material of refuse tote 10. In other embodiments, the thickened portions comprise the same polymer material as the remaining portions of refuse tote 10, however the dimensions of the thickened portions are selected to achieve the desired weight ratios, discussed above.

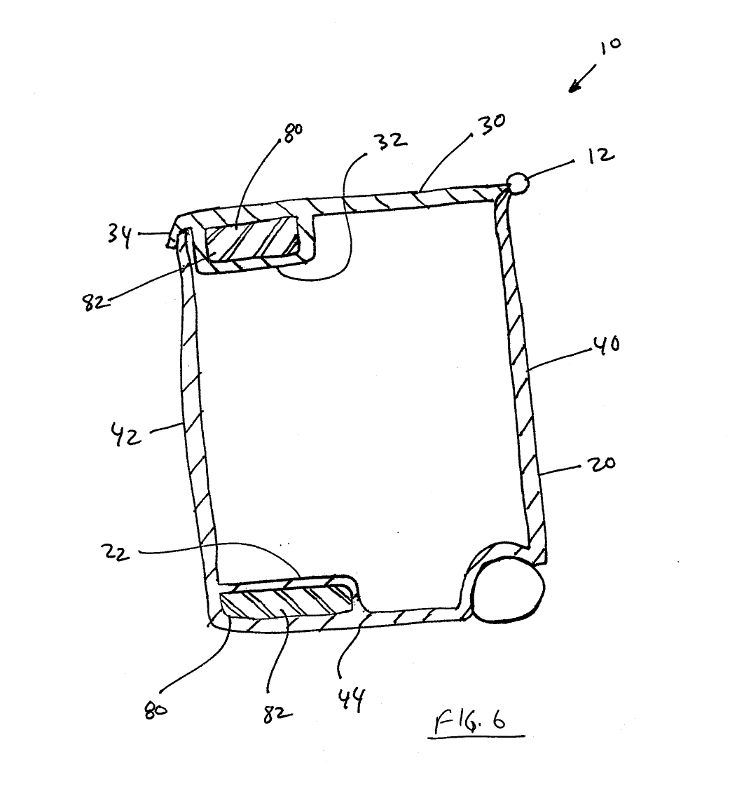

Referring now to FIG. 6, in some embodiments container ballast 22 and/or lid weight 32 comprise a compartment 80 into which a weighted material 82 is inserted and stored. Compartment 80 may further include a spout or other opening whereby to insert weighted material 82 into compartment 80. In some embodiments, compartment 80 may be accessed by a user, such as by removing a cap or covering (not shown). Following access to compartment 80, the user may reclose compartment 80 to retain weight material 82 in compartment 80.

Weighted material 82 may comprise any material that is compatible for use with a refuse tote. For example, in some embodiments weighted material 82 comprises a liquid, such as water or antifreeze. In other embodiments weighted material 82 comprises a cementitious material. Further, in other embodiments weighted material 82 comprises a metallic material in the form of lead shot or another type of shot material.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A refuse tote, comprising:
a base container having a bottom surface and a center of gravity;
a lid hingedly coupled to the base container at a rear of the base container;
a lid weight coupled to the lid at a position opposite the hinged connection of the lid to the base container; and
a container ballast coupled to the bottom surface of the base container at a position forward of the center of gravity.
